(19) United States
(12) Patent Application Publication
(10) Pub. No.: US 2012/0061034 A1
(43) Pub. Date: Mar. 15, 2012

(54) Slim Bottom Bar Wedge Lock

(76) Inventor: Philip Ng, Thornhill (CA)

(21) Appl. No.: 12/880,268

(22) Filed: Sep. 13, 2010

(51) Int. Cl. E06B 9/42

(52) U.S. Cl. 160/290.1

(57) ABSTRACT

There is disclosed a bottom bar for attachment to a lower edge of a window blind. The bottom bar includes an elongated tube having a bottom and a pair of opposing side walls separated by a space and an elongated slit extending along the tube, the slit communicating with the space. The slit is dimensioned to permit the lower edge of the window blind to pass through. The bottom bar further includes an elongated lock member dimensioned to fit within the space, the elongated lock member dimensioned to be too small to pass through the slit. The lock member has a flat side wall for attachment to the lower edge of the window blind by an adhesive. The opposing side walls of the elongated tube are tapered toward each other from the bottom towards the slit such that the opposing side walls abut the flat side wall of the lock member when the lock member moves towards the slit.

### FIELD OF THE INVENTION

The invention relates generally to bottom bars for blinds, particularly for use with roller blinds.

### BACKGROUND OF THE INVENTION

Window blinds in general, and roller blinds in particular, include a long fabric blind which is gathered in a roller positioned at or near the top of the window frame. The blind hangs down from the roller by the force of gravity. The lower edge of the blind is generally weighed down with an elongated bar which extends the entire width of the blind. This elongated bar, usually referred to as a bottom bar, serves three useful purposes, namely as a weight to weigh down the lower edge of the blind, as a dressing to improve the appearance of the lower edge of the bar, and as a means to allow a user to pull down the blind by grasping the bottom bar and pulling down. The bottom bar generally consists of an elongated hollow tube of some sort having an elongated slit to permit the edge of the blind to pass into the tube's interior. The bottom bar is mounted to the lower edge of the blind by a variety of methods. Since the attachment must be secure, a common method is to rivet a series of lugs onto the bottom edge of the blind and then slide the bottom bar over the lugs with the blind exiting the elongated slit in the bottom bar. While secure, this method leads to an unsightly “scalloping” of the bottom edge of the blind where the lugs are riveted. Therefore, an improved method of securely mounting the bottom bar to the bottom edge of the blind is required.

### SUMMARY OF THE INVENTION

In accordance with one aspect of the present invention, there is provided a bottom bar for attachment to a lower edge of a window blind. The bottom bar includes an elongated tube having a bottom and a pair of opposing side walls separated by a space and an elongated slit extending along the tube, the slit communicating with the space. The slit is dimensioned to permit the lower edge of the window blind to pass through. The bottom bar further includes an elongated lock member dimensioned to fit within the space, the elongated lock member dimensioned to be too small to pass through the slit. The lock member has a flat side wall for attachment to the lower edge of the window blind by an adhesive. The opposing side walls of the elongated tube are tapered toward each other from the bottom towards the slit such that the opposing side walls abut the flat side wall of the lock member when the lock member moves towards the slit.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a perspective view of a bottom bar made in accordance with the present invention coupled to the bottom edge of a window blind.

FIG. 2 is a cross sectional view of the bottom bar shown in FIG. 1.

FIG. 3 is a perspective view of the lock member portion of the present invention showing an adhesive strip placement for attachment to the bottom end of a blind.

In the drawings like characters of reference indicate corresponding parts in the different figures.

### DETAILED DESCRIPTION OF THE INVENTION

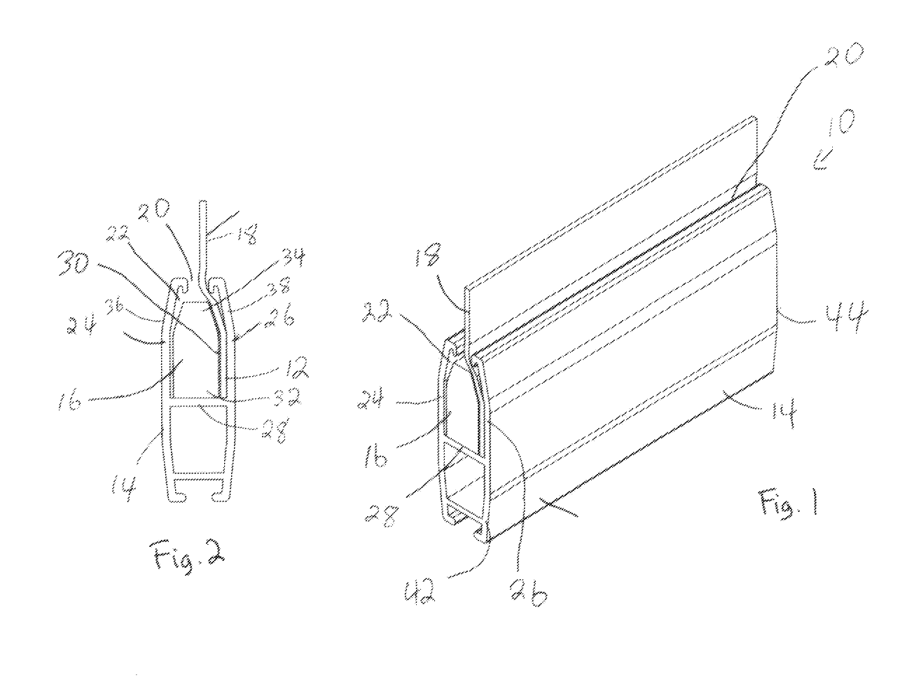

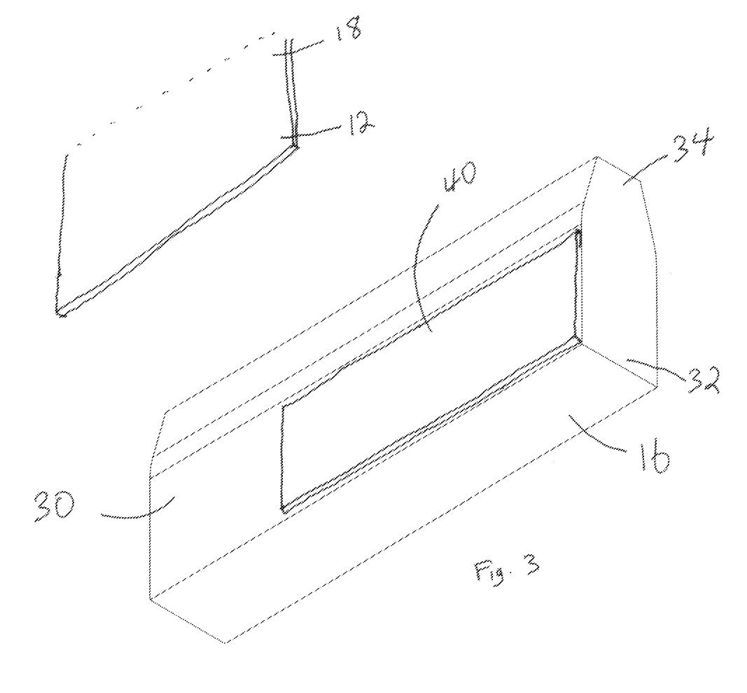

Referring to FIGS. 1 and 2, a bottom bar made in accordance with one aspect of the present invention is shown generally as item 10 and includes an elongated tube 14 having inner space 22 dimensioned to receive lock member 16. Tube 14 has bottom 28 and opposing side walls 24 and 26 separated by space 22 and slit 20. Slit 20 extends along the entire length of tube 14. Lock member 16 has flat side wall 30 onto which bottom end 12 of fabric sheet 18 is adhered by means of an adhesive, such as a strip of double sided adhesive tape. Opposing walls 24 and 26 taper between bottom 28 and slit 20 such that they have tapered portions 36 and 38, respectively. Likewise, lock member 16 tapers between bottom side 32 and upper side 34. Slit 20 is dimensioned to prevent lock member 16 from passing out of the slit while allowing sheet 18 to pass through. Opposing side walls 24 and 26 taper towards slit 20 such that flat side wall 30 abuts one of the opposing side walls when lock member 16 moves towards slit 20. Opposing side walls 24 and 26 are preferably configured such that the taper applied to the opposing side walls approximately conforms to the taper formed on lock member 16. While not clearly shown in FIGS. 1 and 2, bottom bar 10 extends along the entire length of blind 18. It will be appreciated that the length of tube 14 and lock member 16 are intended to be cut to size so as to extend across the whole of bottom end 12 of fabric blind 18.

As better seen in FIG. 3, flat side wall 30 of lock member 16 is firmly adhered to end 12 of fabric blind 18 by an adhesive, preferably by a strip 40 of double sided adhesive tape. Double sided adhesive tape 40 is mounted to flat side wall 30 along the entire length lock member 16. This permits a continual and uninterrupted bonding between end 12 of fabric blind 18 and lock member 16. Since the entire width of end 12 is bounded to lock member 16, there will be no pressure points created along the length of the lock member and end 12 can remain smooth and un-scalloped.

Referring back to FIGS. 1 and 2, after end 12 of fabric blind 18 is bonded to lock member 16, the lock member and fabric blind are inserted into space 22 through one of ends 42 or 44 of tube 14. It will be appreciated that tube 14 and lock member 16 can be several meters long depending on the width of blind 18. Fabric blind 18 projects through slit 20 of tube 14. As tube 14 is forced downward by the action of gravity (or by the action of someone grasping the bar and pulling downward), lock member 16 will move towards slit 20. As lock member 16 moves towards slit 20, opposing side walls 24 and 26 bear against the lock member and in particular bear against flat side wall 30, thereby forcing end 12 of fabric blind 18 tighter against the flat side wall. In effect, end 12 of the fabric blind is pinched or clamped between sidewalls 24 (or 26) and wall 30. This has the effect of keeping end 12 bounded to lock member 16 and prevents the end of the fabric blind from dislodging from the lock member. It has been discovered that this arrangement provides far stronger bond between the fabric blind and the bottom bar. Simply bonding the end of the fabric blind to the bottom bar does not yield as strong an attachment as the present invention.

A specific embodiment of the present invention has been disclosed; however, several variations of the disclosed embodiment could be envisioned as within the scope of this invention.

It is to be understood that the present invention is not limited to the embodiments described above, but encompasses any and all embodiments within the scope of the following claims.

Therefore, what is claimed is:

1. A bottom bar for attachment to a lower edge of a window blind, said bottom bar comprising:
a. An elongated tube having a bottom and a pair of opposing side walls separated by a space and an elongated slit extending along the tube, the slit communicating with the space, the slit dimensioned to permit the lower edge of the window blind to pass through;
b. An elongated lock member dimensioned to fit within the space, the elongated lock member dimensioned to be too small to pass through the slit;
c. The lock member having a flat side wall for attachment to the lower edge of the window blind by an adhesive,
d. The opposing side walls being tapered toward each other from the bottom towards the slit such that the opposing side walls abut the flat side wall of the lock member when the lock member moves towards the slit.

2. The bottom bar as defined in claim 1 wherein the adhesive is a strip of double sided adhesive tape.

3. The bottom bar as defined in claim 1 wherein the lock member has an upper side and a lower side and opposite ends, the upper side being oriented towards the elongated slit, the flat side wall extending between the lower side and the upper side.

4. The bottom bar as defined in claim 3 wherein the bottom bar is tapered from the bottom side to the top side such that the flat side wall.

5. The bottom bar as defined in claim 4 wherein the adhesive is a strip of double sided adhesive tape.
